(19) United States
(12) Patent Application Publication
(10) Pub. No.: US 2026/0163687 A1
(43) Pub. Date: Jun. 11, 2026

(54) METHOD FOR UPLINK MULTIPLE TRANSMISSION RECEPTION POINT OPERATION WITH UPLINK COVERAGE ENHANCEMENT

(71) Applicant: APPLE INC., Cupertino, CA (US)

(72) Inventors: Yushu Zhang, Beijing (CN); Chunhai Yao, Beijing (CN); Dawei Zhang, Saratoga, CA (US); Haitong Sun, Cupertino, CA (US); Oghenekome Oteri, San Diego, CA (US); Sigen Ye, San Diego, CA (US); Wei Zeng, Saratoga, CA (US)

(21) Appl. No.: 18/706,419

(22) PCT Filed: Nov. 5, 2021
(86) PCT No.: PCT/CN2021/128952

§ 371 Date: May 1, 2024

(51) Int. Cl. H04L 5/00; H04B 7/06; H04W 52/36; H04W 72/0446

(52) U.S. Cl. CPC H04L 5/0044; H04B 7/06952; H04W 52/365; H04W 72/0446

(57) ABSTRACT

Systems and methods for simultaneously using multiple transmission reception point (mTRP) operation in uplink and one or more uplink coverage enhancement methods are described herein. In some embodiments, mTRP may be used along with methods for transmitting a transport block (TB) of an uplink channel over multiple slots. In some embodiments, methods enabling mTRP are enabled to be used along with methods of cross-slot channel estimation by a base station. In some embodiments, mTRP may be used along with methods where a base station can dynamically update the number of repetitions of an uplink channel transmitted by a user equipment (UE) (e.g., using downlink control information (DCI)) to use a single transmission of the uplink channel.

### TECHNICAL FIELD

This application relates generally to wireless communication systems, including such wireless communications systems that can use multiple transmission reception points in uplink at the same time that one or more uplink coverage enhancement methods are used.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

The use of multiple TRPs by an entity (e.g., a UE) may be referred to generally herein as multi-TRP or mTRP.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a beam mapping pattern for use during uplink mTRP operation, according to an embodiment.

FIG. 2 illustrates a beam mapping pattern for use during uplink mTRP operation, according to an embodiment.

FIG. 3 illustrates a diagram for an embodiment where TBs are sent using the same beam over multiple consecutive slots for that beam, according to a beam mapping pattern.

FIG. 4 illustrates a diagram for an embodiment where TBs are sent using the same beam over multiple non-consecutive slots for that beam, according to a beam mapping pattern.

FIG. 5 illustrates a diagram for an embodiment where TBs are sent over slots for different beams.

FIG. 6 illustrates a method of a base station, according to an embodiment.

FIG. 7 illustrates a method of a base station, according to an embodiment.

FIG. 8 illustrates a diagram for a case where a UE is not able to predict a transmission status for a slot used by a TB that is being sent over multiple slots.

FIG. 9 illustrates a method of a UE, according to an embodiment.

FIG. 10 illustrates a diagram for an embodiment where cross-slot estimation is performed in the context of an uplink mTRP environment using multiple beams.

FIG. 11 illustrates a diagram for an embodiment where cross-slot estimation is performed in the context of an uplink mTRP environment using multiple beams.

FIG. 12 illustrates a method of a base station, according to an embodiment.

FIG. 13 illustrates a method of a base station, according to an embodiment.

FIG. 14 illustrates a method of a UE, according to an embodiment.

FIG. 15 illustrates a method of a UE, according to an embodiment.

FIG. 16 illustrates an example architecture of a wireless communication system, according to embodiments disclosed herein.

FIG. 17 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

In 3GPP Release 17, a use of multiple transmission reception point (mTRP) operation for uplink transmissions by the UE may be supported. In uplink mTRP, a UE may transmit an uplink channel (such as a physical uplink control channel (PUCCH) or a physical uplink shared channel (PUSCH)) repeatedly across a pair of beams, with each beam configured for communication with a different one of multiple transmission reception points (TRPs) used during the uplink mTRP operation. Each repetition of the uplink channel may include a transport block (TB) having the same data as a TB of another such repetition. Note that, as used herein, the term “repetition” may be used to reference the first (in time) instance of the repeated item (as well as any subsequent instances of the repeated item). For example, the case of a transmission of an entity two times may be understood in terms of a first repetition and a second repetition of that entity, for a total of two repetitions of that entity.

In such cases, it may be that there are two or more such repetitions of the uplink channel across the pair of beams. The repetitions of the uplink channel may be multiplexed in a time domain multiplexing (TDM) manner. The repetitions can be multiplexed in an inter-slot manner or an intra slot manner. It is contemplated that a repetition of an uplink channel may take part of a slot, a whole slot, or more than one slot (as the case may be). Further, it is contemplated that a single slot could in some cases contain multiple repetitions of the uplink channel.

In conjunction with this uplink mTRP operation, multiple beam mapping patterns may be supported. These beam mapping patterns may be configured by radio resource control (RRC) messaging.

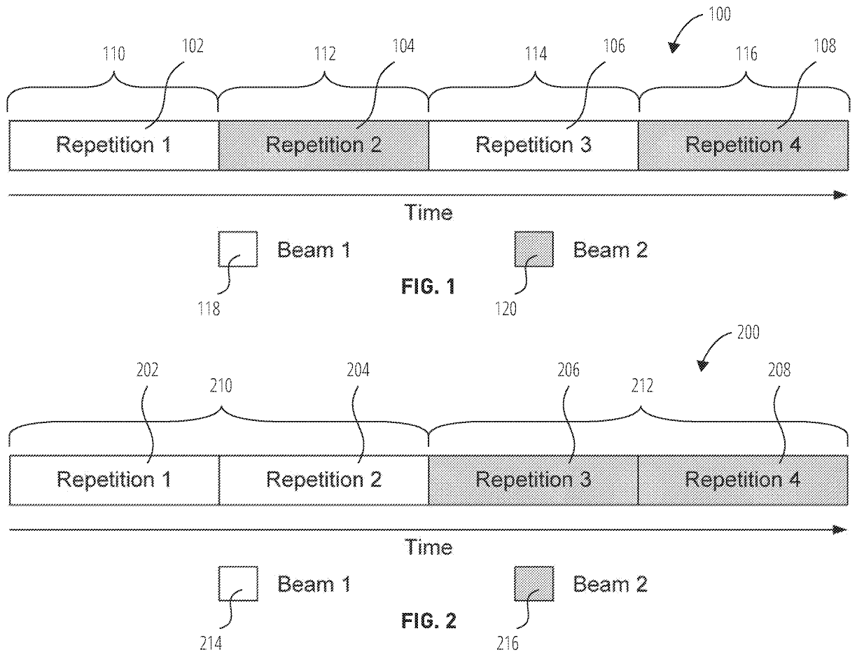

FIG. 1 illustrates a beam mapping pattern 100 for use during uplink mTRP operation, according to an embodiment. The beam mapping pattern 100 uses a cyclic beam mapping pattern (cyclic mapping). A transmission of an uplink channel occurs four times, as illustrated by the first repetition 102, the second repetition 104, the third repetition 106, and the fourth repetition 108, each occurring during a corresponding time resource.

As used herein, an element of a beam mapping pattern may be understood to be one or more consecutive time resources that are for (e.g., used to transmit data on) the same beam (e.g., for an associated TRP).

When using cyclic mapping, it may be that beams are used for the time resources in turns (e.g., on an element-wise basis within the pattern). As illustrated, the beam mapping pattern 100 cycles through a first element 110 corresponding to a first beam 118, a second element 112 corresponding to a second beam 120, a third element 114 corresponding to the first beam 118, and a fourth element 116 corresponding to the second beam 120. Accordingly, the beam mapping pattern 100 represents cyclic mapping because each one of the beam-alternating elements 110 through 116 is mapped to time resources having a corresponding one of the repetitions 102 through 108, with the result that the first repetition 102 is transmitted on the first beam 118, the second repetition 104 is transmitted on the second beam 120, the third repetition 106 is transmitted on the first beam 118, and the fourth repetition 108 is transmitted on the second beam 120 (e.g., alternating on a per-time resource basis).

FIG. 2 illustrates a beam mapping pattern 200 for use during uplink mTRP operation, according to an embodiment. The beam mapping pattern 200 uses a sequential beam mapping pattern (sequential mapping). A transmission of an uplink channel occurs four times, as illustrated by the first repetition 202, the second repetition 204, the third repetition 206, and the fourth repetition 208, each occurring during a corresponding time resource.

When using sequential mapping, it may be that a first beam is used to a first number (greater than one) of consecutive time resources and then a second beam is used for a second number (greater than one) of consecutive time resources. The first number of consecutive time resources and the second number of consecutive time resources may be the same. As illustrated, the beam mapping pattern 200 uses a first element 210 corresponding to a first beam 214 followed by a second element 212 corresponding to the second beam 216. Accordingly, the beam mapping pattern 200 represents sequential mapping because the first element 210 is mapped to two time resources having consecutive repetitions (the first repetition 202 and the second repetition 204) and the second element 212 is mapped to two time resources having consecutive repetitions (the third repetition 206 and the fourth repetition 208), with the result that the first repetition 202 and the second repetition 204 are transmitted on the first beam 214, and the third repetition 206 and the fourth repetition 208 are transmitted on the second beam 216 (in that order).

In 3GPP Release 17, uplink coverage enhancement may be supported. Uplink coverage enhancement may comprise the support of one or more of the following three features.

In a first feature of uplink coverage enhancement, a base station may configure a UE to transmit a single TB (e.g., of an uplink channel such as a PUSCH) over multiple slots. This may differ from repetition-based transmission, where the same TB is transmitted multiple times (e.g., in each slot). Compared to repetition-based operation, this first feature may eliminate some TB cyclic redundancy check (CRC) overhead (e.g., due to a fewer number of TB being transmitted as opposed to the repetition case).

In a second feature of uplink coverage enhancement, a base station may perform cross-slot channel estimation, which may result in improved channel performance (e.g., over a case where the base station instead estimates the channel only over a single slot). A cross-slot channel estimation may be performable over consecutive slots that use a same beam/transmission precoder (such that the estimation remains coherent across the consecutive slots). A time-domain bundling window may be configured that represents a minimum number of consecutive slots over which the base station performs the cross-slot channel estimation.

In a third feature of uplink coverage enhancement, a base station may dynamically update the number of repetitions of a PUCCH by using downlink control information (DCI). This may allow the base station to adapt the number of repetitions to current channel conditions, as needed.

Wireless communication systems that can operate (simultaneously) according to (both) uplink mTRP and uplink coverage enhancement may be desirable, in order to achieve associated benefits of both uplink mTRP and uplink coverage enhancement. In order to interwork these features, multiple potential issues and corresponding solutions are considered.

A first issue impacting the interworking of uplink mTRP and uplink coverage enhancement may be that systems and methods for transmitting a TB of an uplink channel over multiple slots (described above as a first feature of uplink coverage enhancement) in the context of an environment where uplink mTRP can occur have not been defined. Accordingly, it may be desirable to cause beam mapping (and corresponding TB placement) to occur within the system according to a defined manner. In order to perform beam mapping (and corresponding uplink channel TB placement) within the system according to a defined manner, four options are provided.

In a first option, it may be that sending a TB of an uplink channel over multiple slots may only be enabled when the UE (e.g., that is capable of mTRP operation) is using single-TRP operation.

For example, a base station may send a first type of indication to the UE that instructs the UE to use a single TRP to transmit the uplink channel (e.g., use single-TRP operation). This indication may include a sounding reference signal (SRS) resource indicator (SRI) corresponding to the beam to be used for the single-TRP operation (the beam that corresponds to the single TRP to be used).

A base station may also send a second type of indication to the UE that schedules a transmission of a TB across multiple slots to the single TRP.

In some instances, the first type of indication and the second type of indication may be sent in the same message. For example, the message including the first type of indication and the second type of indication may be a DCI message.

In some instances, the first type of indication may be sent in a first message, and the second type of indication may be sent in a second message. In some cases, the first message may be an RRC message and the second message may be a DCI message. In some cases, the first message may be transmitted or sent after the second message.

In a second option, it may be that sending a TB of an uplink channel over multiple slots may occur such that the TB is sent over time resources for the same beam.

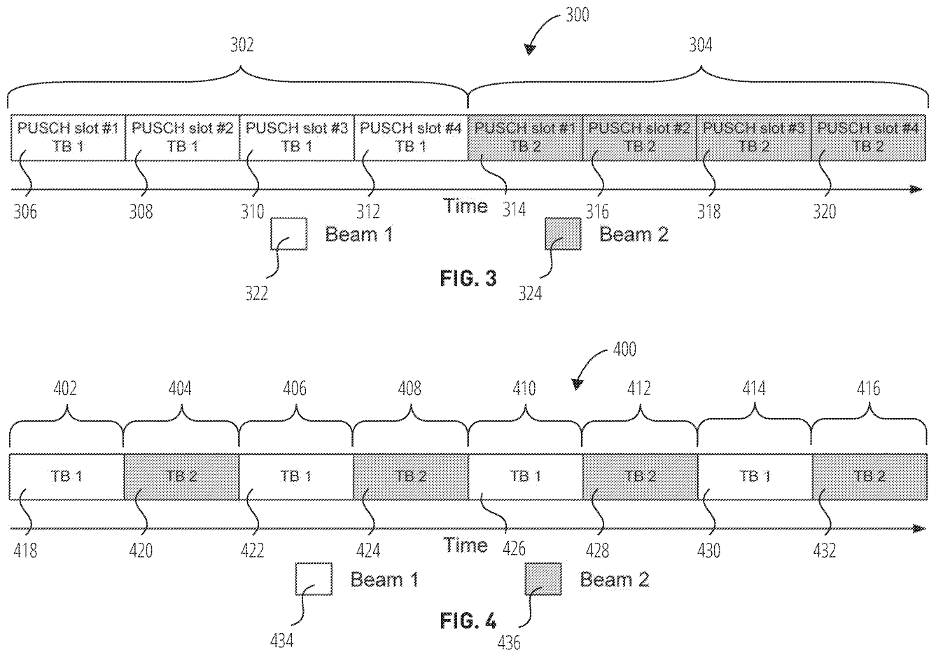

In some cases of the second option, one element of the beam mapping pattern contains all the time resources for the TB transmission. FIG. 3 illustrates a diagram 300 for an embodiment where TBs are sent using the same beam over multiple consecutive slots for that beam, according to a beam mapping pattern. In FIG. 3, each of the first slot 306, the second slot 308, the third slot 310, and the fourth slot 312 is used to send a first PUSCH TB (with each slot having part of the first PUSCH TB, as illustrated). In this case, the first element 302 of the beam mapping pattern maps to the first slot 306, the second slot 308, the third slot 310, and the fourth slot 312. Accordingly, the first PUSCH TB is sent on a first beam 322 corresponding to the first element 302 across these four slots.

Further, each of the fifth slot 314, the sixth slot 316, the seventh slot 318, and the eighth slot 320 is used to send a second PUSCH TB (with each slot having part of the second PUSCH TB, as illustrated). In this case, the second element 304 of the beam mapping pattern maps to the fifth slot 314, the sixth slot 316, the seventh slot 318, and the eighth slot 320. Accordingly, the second PUSCH TB is sent on a second beam 324 corresponding to the second element 304 across these four slots.

In some cases of the second option, elements of the beam mapping pattern each map to a single time resource, and the TB can be sent in non-consecutive time resources for the same beam. FIG. 4 illustrates a diagram 400 for an embodiment where TBs are sent using the same beam over multiple non-consecutive slots for that beam, according to a beam mapping pattern. In FIG. 3, each of the first slot 418, the third slot 422, the fifth slot 426, and the seventh slot 430 are used to send a first PUSCH TB (with each slot having part of the first PUSCH TB, as illustrated). In this case, the first element 402, the third element 406, the fifth element 410, and the seventh element 414 of the beam mapping pattern map respectively to the first slot 418, the third slot 422, the fifth slot 426, and the seventh slot 430. Accordingly, the first PUSCH TB is sent on a first beam 434 corresponding to these elements and across these four slots.

Further, each of the second slot 420, the fourth slot 424, the sixth slot 428, and the eighth slot 432 are used to send a second PUSCH TB (with each slot having part of the second PUSCH TB, as illustrated). In this case, the first second element 404, the fourth element 408, the sixth element 412, and the eighth element 416 of the beam mapping pattern map respectively to the second slot 420, the fourth slot 424, the sixth slot 428, and the eighth slot 432. Accordingly, the second PUSCH TB is sent on a second beam 436 corresponding to these elements and across these four slots.

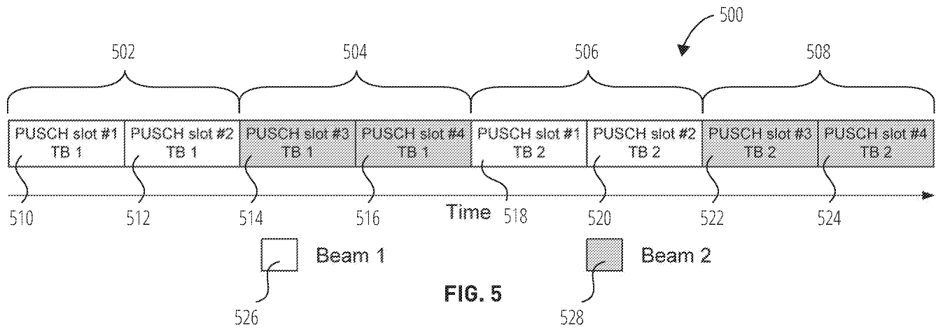

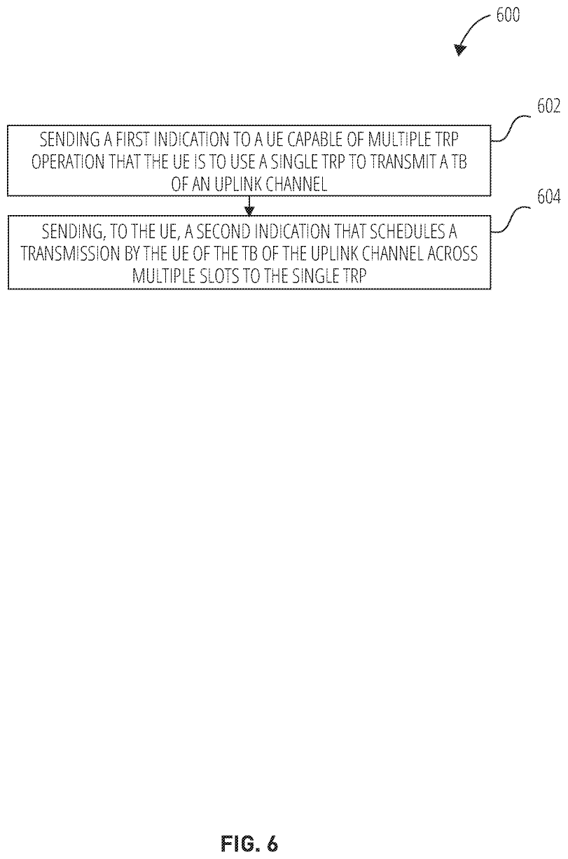

In a third option, it may be that sending a TB of an uplink channel over multiple slots can occur such that the TB is sent over time resources for different beams. FIG. 5 illustrates a diagram 500 for an embodiment where TBs are sent over slots for different beams. In FIG. 5, each of the first slot 510, the second slot 512, the third slot 514, and the fourth slot 516 are used to send a first PUSCH TB (with each slot having part of the first PUSCH TB, as illustrated). In this case, the first element 502 of the beam mapping pattern maps to the first slot 510 and the second slot 512, and the second element 504 of the beam mapping pattern maps to the third slot 514 and the fourth slot 516. Accordingly, a first part of the first PUSCH TB found in the first slot 510 and the second slot 512 is sent on a first beam 526 corresponding to the first element 502, and a second part of the first PUSCH TB found in the third slot 514 and the fourth slot 516 is sent on a second beam 528 corresponding to the second element 504.

Further, each of the fifth slot 518, the sixth slot 520, the seventh slot 522, and the eighth slot 524 are used to send a second PUSCH TB (with each slot having part of the second PUSCH TB, as illustrated). In this case, the third element 506 of the beam mapping pattern maps to the fifth slot 518 and the sixth slot 520, and the fourth element 508 of the beam mapping pattern maps to the seventh slot 522 and the second beam 528. Accordingly, a first part of the second PUSCH TB found in the fifth slot 518 and the sixth slot 520 is sent on a first beam 526 corresponding to the third element 506, and a second part of the second PUSCH TB found in the seventh slot 522 and the eighth slot 524 is sent on a second beam 528 corresponding to the fourth element 508.

The diagram 500 of FIG. 5 is just one possible example of an application of this third option. A base station could configure a mapping type of the beam mapping pattern used (e.g., whether to use a cyclic mapping pattern, or a different sequential mapping pattern having elements covering a different number of time resources) under this third option. It is contemplated that in this third option, the specific beam pattern used could be configured to the UE by higher layer signaling.

For each of the second and third options discussed here, a base station may send a first type of indication to the UE that instructs the UE to use a beam mapping pattern over a plurality of slots. Each element of the beam mapping pattern may correspond to a use of one of a first beam and a second beam. This indication may include SRIs corresponding to the beams to be used (the beams that corresponds to the TRPs to be used).

A base station may send a second type of indication to the UE that schedules a transmission of a TB across the multiple slots. This transmission may be to one or multiple TRPs, according to a correspondence of the beam pattern to the particular multiple slots used for the TB.

In some instances, the first type of indication and the second type of indication may be sent in the same message. For example, the message including the first type of indication and the second type of indication may be a DCI message.

In some instances, the first type of indication may be sent in a first message, and the second type of indication may be sent in a second message. In some cases, the first message may be an RRC message and the second message may be a DCI message. In some cases, the first message may be transmitted or sent after the second message.

It may be that a UE is capable of one or more of an operation according to the second option and/or an operation according to the third option. For example, the UE may be capable of sending a TB across multiple consecutive slots in a single element of a beam mapping pattern (e.g., for some cases of option 2). Further, the UE may be capable of sending a TB across multiple non-consecutive slots across multiple elements of the beam mapping pattern that are for the same beam (e.g., for some cases of option 2). Further, the UE may be capable of dividing multiple slots for a TB between a first element of a beam mapping pattern that is for a first beam and a second element of the beam mapping pattern that is for a second beam (e.g., for option 3). The UE may be able to make an indication that it has one or more of these capabilities to the base station.

The base station may be capable of indicating, to the UE, that slots for a TB will be scheduled using multiple consecutive slots in a single element of a beam mapping pattern (e.g., for some cases of option 2). Further, the base station may be capable of indicating to the UE that slots will be scheduled using multiple elements of the beam mapping pattern that are for the same beam (e.g., for some cases of option 2). Further, the base station may be capable of indicating to the UE that slots to be scheduled for a TB will be divided between a first element of a beam mapping pattern for a first beam and a second element of the beam mapping pattern that is for a second beam (e.g., for option 3). Such an indication may be sent to the UE in response to and/or corresponding to a received UE capability indication, as described above. This indication may be sent in an RRC message or a DCI message. This indication may be made by referencing a time domain resource allocation (TDRA) known at the UE that configures for the use of one or more elements of the beam mapping pattern in the described manner.

FIG. 6 illustrates a method 600 of a base station, according to an embodiment. The method 600 includes sending 602 a first indication to a UE capable of multiple TRP operation that the UE is to use a single TRP to transmit a TB of an uplink channel.

The method 600 further includes sending 604, to the UE, a second indication that schedules a transmission by the UE of the TB of the uplink channel across multiple slots to the single TRP.

In some embodiments of the method 600, the first indication and the second indication are sent in a single message. In some of these embodiments, the single message is a DCI message.

In some embodiments of the method 600, the first indication is sent in a first message, and wherein the second indication is provided in a second message. In some of these embodiments, the first message is a RRC message, and the second message is a DCI message. In some of these embodiments, the first message is transmitted after the second message is transmitted.

In some embodiments of the method 600, the first indication comprises an SRI corresponding to the single TRP.

Embodiments contemplated herein include an apparatus comprising means to perform one or more elements of the method 600. This apparatus may be, for example, an apparatus of a base station (such as a network device 1718 that is a base station, as described herein).

Embodiments contemplated herein include one or more non-transitory computer-readable media comprising instructions to cause an electronic device, upon execution of the instructions by one or more processors of the electronic device, to perform one or more elements of the method 600. This non-transitory computer-readable media may be, for example, a memory of a base station (such as a memory 1722 of a network device 1718 that is a base station, as described herein).

Embodiments contemplated herein include an apparatus comprising logic, modules, or circuitry to perform one or more elements of the method 600. This apparatus may be, for example, an apparatus of a base station (such as a network device 1718 that is a base station, as described herein).

Embodiments contemplated herein include an apparatus comprising: one or more processors and one or more computer-readable media comprising instructions that, when executed by the one or more processors, cause the one or more processors to perform one or more elements of the method 600. This apparatus may be, for example, an apparatus of a base station (such as a network device 1718 that is a base station, as described herein).

Embodiments contemplated herein include a signal as described in or related to one or more elements of the method 600.

Embodiments contemplated herein include a computer program or computer program product comprising instructions, wherein execution of the program by a processing element is to cause the processing element to carry out one or more elements of the method 600. The processor may be a processor of a base station (such as a processor(s) 1720 of a network device 1718 that is a base station, as described herein). These instructions may be, for example, located in the processor and/or on a memory of the base station (such as a memory 1722 of a network device 1718 that is a base station, as described herein).

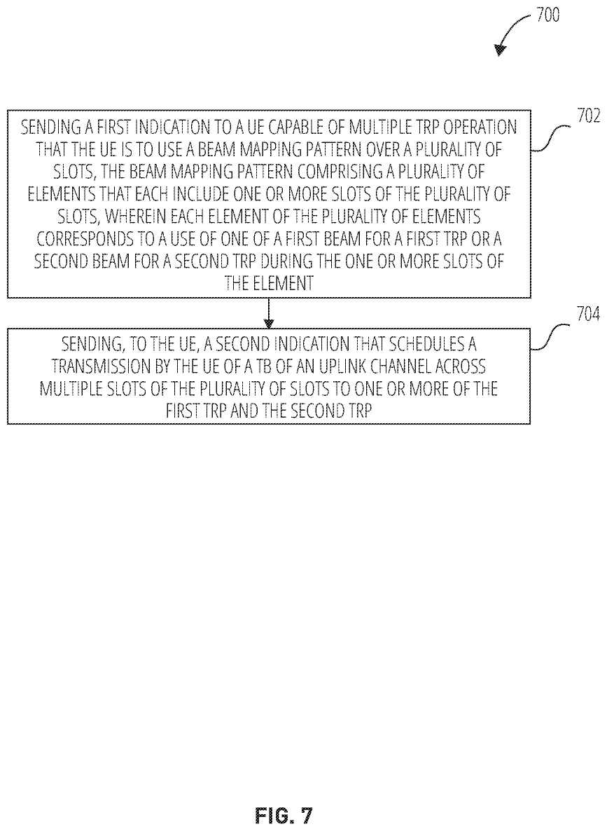

FIG. 7 illustrates a method 700 of a base station, according to an embodiment. The method 700 includes sending 702 a first indication to a UE capable of multiple TRP operation that the UE is to use a beam mapping pattern over a plurality of slots, the beam mapping pattern comprising a plurality of elements that each include one or more slots of the plurality of slots, wherein each element of the plurality of elements corresponds to a use of one of a first beam for a first TRP or a second beam for a second TRP during the one or more slots of the element.

The method 700 further includes sending 704, to the UE, a second indication that schedules a transmission by the UE of a TB of an uplink channel across multiple slots of the plurality of slots to one or more of the first TRP and the second TRP.

In some embodiments of the method 700, the multiple slots are located in a same element of the beam mapping pattern that corresponds to the use of the first beam.

In some embodiments of the method 700, a first slot of the multiple slots is located in a first element of the beam mapping pattern that corresponds to a use of the first beam and a second slot of the multiple slots is located in a second element of the beam mapping pattern that corresponds to the use of the first beam.

In some embodiments of the method 700, a first slot of the multiple slots is located in a first element of the beam mapping pattern that corresponds to a use of the first beam and a second slot of the multiple slots is located in a second element of the beam mapping pattern that corresponds to a use of the second beam.

In some embodiments of the method 700, the first indication and the second indication are sent in a single message. In some of these embodiments, the single message is a DCI message.

In some embodiments of the method 700, the first indication is sent in a first message, and wherein the second indication is provided in a second message. In some of these embodiments, the first message is an RRC message, and the second message is a DCI message. In some of these embodiments, the first message is transmitted after the second message is transmitted.

In some embodiments, the method 700 further includes receiving, from the UE, a third indication of whether the UE is capable of dividing the multiple slots between a first element of the beam mapping pattern that corresponds to a use of the first beam a second element of the beam mapping pattern that corresponds to a use of the second beam.

In some embodiments, the method 700 further includes sending, to the UE, a third indication of whether the multiple slots will be scheduled using each of a first element of the beam mapping pattern that corresponds to a use of the first beam a second element of the beam mapping pattern that corresponds to a use of the second beam. In some of these embodiments, the third indication is sent in a RRC message. In some of these embodiments the third indication is sent in a DCI message. In some embodiments using this DCI, the third indication is made by referencing a TDRA configuring for the use of one or more of the first element and the second element.

Embodiments contemplated herein include an apparatus comprising means to perform one or more elements of the method 700. This apparatus may be, for example, an apparatus of a base station (such as a network device 1718 that is a base station, as described herein).

Embodiments contemplated herein include one or more non-transitory computer-readable media comprising instructions to cause an electronic device, upon execution of the instructions by one or more processors of the electronic device, to perform one or more elements of the method 700. This non-transitory computer-readable media may be, for example, a memory of a base station (such as a memory 1722 of a network device 1718 that is a base station, as described herein).

Embodiments contemplated herein include an apparatus comprising logic, modules, or circuitry to perform one or more elements of the method 700. This apparatus may be, for example, an apparatus of a base station (such as a network device 1718 that is a base station, as described herein).

Embodiments contemplated herein include an apparatus comprising: one or more processors and one or more computer-readable media comprising instructions that, when executed by the one or more processors, cause the one or more processors to perform one or more elements of the method 700. This apparatus may be, for example, an apparatus of a base station (such as a network device 1718 that is a base station, as described herein).

Embodiments contemplated herein include a signal as described in or related to one or more elements of the method 700.

Embodiments contemplated herein include a computer program or computer program product comprising instructions, wherein execution of the program by a processing element is to cause the processing element to carry out one or more elements of the method 700. The processor may be a processor of a base station (such as a processor(s) 1720 of a network device 1718 that is a base station, as described herein). These instructions may be, for example, located in the processor and/or on a memory of the base station (such as a memory 1722 of a network device 1718 that is a base station, as described herein).

A further aspect of this first issue (transmitting a TB of an uplink channel over multiple slots in the context of mTRP use) is that in such cases, the manner of reporting a power headroom (PHR) for such a TB may need to be defined in view of potential issues that may arise. For example, it may be that a UE is not able to predict a transmission status for some time resources (e.g., slots) used by the TB, which presents difficulties in determining a maximum transmission power for an actual PHR calculation.

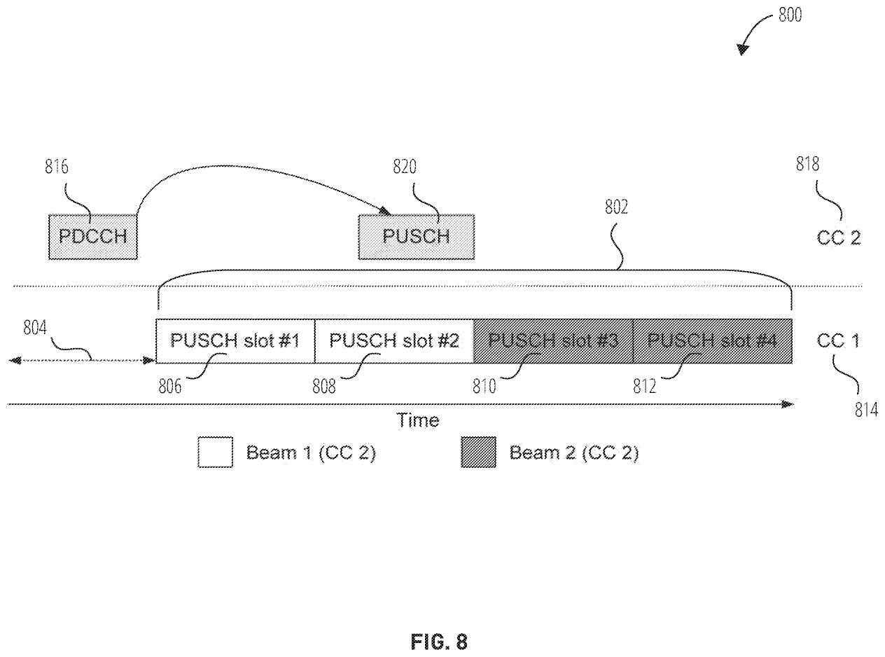

FIG. 8 illustrates a diagram 800 for a case where a UE is not able to predict a transmission status for a slot used by a TB that is being sent over multiple slots. Prior to a preparation delay 804, a UE may determine to send a TB of a first PUSCH 802 across the first slot 806, the second slot 808, the third slot 810, and the fourth slot 812, on a first component carrier (CC) 814. The UE may generate a PHR corresponding to the transmission of the TB during this time (prior to the preparation delay 804). Then, during the preparation delay 804 (and after the UE has determined to send the TB of the first PUSCH 802 and generated the corresponding PHR), a physical downlink control channel (PDCCH) 816 arrives at the UE (e.g., on a second CC 818, though this is not strictly required) that schedules a second PUSCH 820 on the second CC 818 during the time of the second slot 808.

At a time of the second slot 808, the UE accordingly uses at least some transmission power to transmit the second PUSCH 820 on the second CC 818, resulting in less transmission power being used to transmit the portion of the TB of the first PUSCH 802 found in the second slot 808 than what may have been assumed when the PHR for the TB was generated. Accordingly, a method for using PHR in a wireless communication system sent corresponding to the TB of the first PUSCH 802 may be defined in a manner such that the system accounts for this possibility.

In a first case, it may be that a single PHR of the TB is to be reported when a TB is transmitted over multiple slots. This PHR may then be transmitted to the (single) TRP.

In a first embodiment of single PHR, it may be that a virtual PHR is used, which can be calculated based on some predefined power control settings using:

$${PH}_{type 1 , b , f , c} ( i , j , {q}_{d} , l ) = {\tilde{P}}_{CMAX , f , c} ( i ) - \{ {P}_{O \_ PUSCH , b , f , c ,} ( j ) + {α}_{b , f , c ,} ( j ) \cdot {PL}_{b , f , c ,} ( {q}_{d} ) + {f}_{b , f , c ,} ( i , l ) \}$$

as described in 3GPP TS 38.213, Physical Layer Procedures for Control, v. 16.7.0 (September 2021), Section 7.7.1. In some cases, such a virtual PHR may alternatively be called a “reference PHR” or a “reference format PHR,” as known to those of skill in the art. This virtual PHR may be calculated based on a reference PUSCH.

In a second embodiment using a single PHR, it may be that the actual PHR is calculated based on a power control setting for the first slot of the multiple slots used to send the TB.

In a second case, it may be that two PHRs for the TB are to be reported when a TB is transmitted over multiple slots. These PHRs may then be transmitted to their corresponding TRPs.

In a first embodiment of this second case, there may be one PHR corresponding to each TRP/for each TRP used for the multiple slots of the TB (e.g., when the TB is sent using multiple beams, and/or when the base station configures a UE to report TRP-specific PHRs). In a first embodiment of this second case, the first PHR and the second PHR are both be virtual PHR, each calculated (e.g., using the formula discussed above) based on default power control settings for the corresponding TRP.

In a second embodiment of this second case, the first PHR may be an actual PHR calculated based on a power control setting for the first slot of the multiple slots used to send the TB (e.g., where this PHR is calculated for the TRP of the beam used for the first slot), and the second PHR is a virtual PHR calculated (e.g., using the formula discussed above) based on default power control settings for the second TRP.

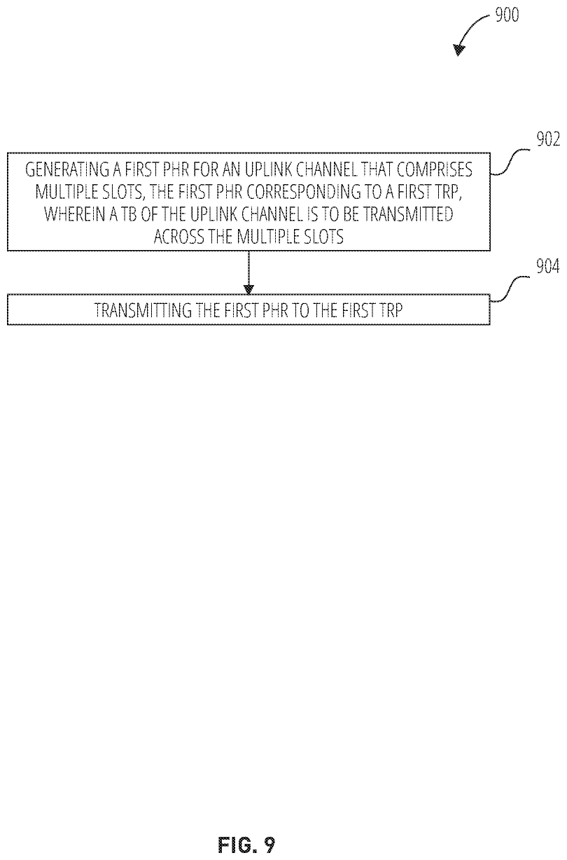

FIG. 9 illustrates a method 900 of a UE, according to an embodiment. The method 900 includes generating 902 a first PHR for an uplink channel that comprises multiple slots, the first PHR corresponding to a first TRP, wherein a TB of the uplink channel is to be transmitted across the multiple slots.

The method 900 further includes transmitting 904 the first PHR to the first TRP.

In some embodiments of the method 900, the first PHR is a virtual PHR.

In some embodiments of the method 900, the first PHR is an actual PHR that is calculated based on a power control setting of a first slot of the multiple slots.

In some embodiments, the method 900 further includes generating a second PHR for the uplink channel, the second PHR corresponding to a second TRP; and transmitting the second PHR to the second TRP. In some of these embodiments, a first portion of the multiple slots are used to transmit a first portion of the TB, and wherein a second portion of the multiple slots are used to transmit a second portion of the TB. In some of these embodiments, the first PHR is a first virtual PHR calculated based on first default power settings for the first TRP, and the second PHR is a second virtual PHR that is calculated based on second default power control settings for the second TRP. In some of these embodiments, the first PHR is an actual PHR calculated based on a power control setting of a first slot of the multiple slots, wherein the first slot is to be transmitted to the first TRP, and the second PHR is a virtual PHR that is calculated based on default power control settings for the second TRP.

Embodiments contemplated herein include an apparatus comprising means to perform one or more elements of the method 900. This apparatus may be, for example, an apparatus of a UE (such as a wireless device 1702 that is a UE, as described herein).

Embodiments contemplated herein include one or more non-transitory computer-readable media comprising instructions to cause an electronic device, upon execution of the instructions by one or more processors of the electronic device, to perform one or more elements of the method 900. This non-transitory computer-readable media may be, for example, a memory of a UE (such as a memory 1706 of a wireless device 1702 that is a UE, as described herein).

Embodiments contemplated herein include an apparatus comprising logic, modules, or circuitry to perform one or more elements of the method 900. This apparatus may be, for example, an apparatus of a UE (such as a wireless device 1702 that is a UE, as described herein).

Embodiments contemplated herein include an apparatus comprising: one or more processors and one or more computer-readable media comprising instructions that, when executed by the one or more processors, cause the one or more processors to perform one or more elements of the method 900. This apparatus may be, for example, an apparatus of a UE (such as a wireless device 1702 that is a UE, as described herein).

Embodiments contemplated herein include a signal as described in or related to one or more elements of the method 900.

Embodiments contemplated herein include a computer program or computer program product comprising instructions, wherein execution of the program by a processor is to cause the processor to carry out one or more elements of the method 900. The processor may be a processor of a UE (such as a processor(s) 1704 of a wireless device 1702 that is a UE, as described herein). These instructions may be, for example, located in the processor and/or on a memory of the UE (such as a memory 1706 of a wireless device 1702 that is a UE, as described herein).

A second issue impacting the interworking of uplink mTRP and uplink coverage enhancement may be that systems and methods for performing cross-slot channel estimation (described above as a second feature of uplink coverage enhancement) in the context of an environment where uplink mTRP can occur may not be defined. Accordingly, it may be desirable to provide beam mapping pattern enhancements to enable cross-slot channel estimation to occur in the mTRP context in a defined manner.

A time-domain bundling window K may be defined that represents the number of consecutive time resources that are to be used by the base station for the cross-slot channel estimation. A beam pattern used to transmit time resources between, e.g., first and second TRPs corresponding to two beams should accordingly ensure that there are at least K time resources within elements of the beam mapping pattern. This allows space for cross-slot channel estimation to occur on a single beam (thereby making the cross-slot channel estimation coherent).

In a first option, a new beam mapping pattern may be defined that has this characteristic. For example, it may be that a first consecutive half of a group of time resources (e.g., that are each used to send a repetition of an uplink channel transmission) are mapped to a first beam pattern element for a first beam, and that a second consecutive half of a group of time resources are mapped to a second beam pattern element for a second beam. It may be that in some cases, this type of pattern is enabled when the time resources having the uplink channel repetitions are slots.

Accordingly, a base station may generate and send an indication to a UE that the UE is to transmit a number of uplink channel repetitions to the UE and that instructs the UE to transmit a first half of the uplink channel repetitions on a first beam and a second half of the uplink channel repetitions on a second beam. Each of the uplink channel repetitions may correspond to its own slot. The base station may also send an indication that cross-slot channel estimation is enabled to the UE.

In alternate cases corresponding to this first option, rather than relying on a base station indication, it may be that the UE is pre-configured to transmit a first half of the uplink channel repetitions on a first beam and a second half of the uplink channel repetitions on a second beam as described.

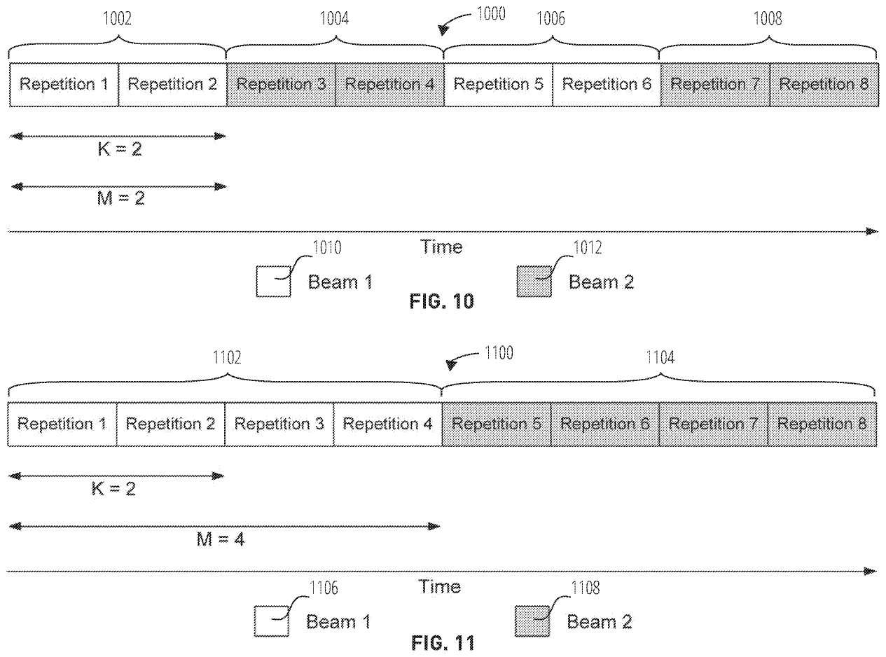

In a second option, it may be that a sequential beam mapping pattern is used. The base station may configure a first beam pattern element to map to a number M of (more than one) consecutive time resources. FIG. 10 illustrates a diagram 1000 for an embodiment where cross-slot estimation is performed in the context of an uplink mTRP environment using multiple beams. As illustrated, the beam mapping pattern comprises a first element 1002, a second element 1004, a third element 1006, and a fourth element 1008, with the first element 1002 and the third element 1006 using a first beam 1010 and the second element 1004 and the fourth element 1008 using a second beam 1012. Each of the elements 1002 to 1008 includes M=2 slots (with each slot having an uplink channel repetition). In the example of FIG. 10, the base station may wish to perform cross-slot estimation with a time-domain bundling window of K=2. Accordingly, because there are at least two slots in each element 1002 through 1008, cross-slot estimation may be performed in K=2 consecutive slots of each of the elements 1002 through 1008.

FIG. 11 illustrates a diagram 1100 for an embodiment where cross-slot estimation is performed in the context of an uplink mTRP environment using multiple beams. As illustrated, the beam mapping pattern comprises a first element 1102 and a second element 1104, with the first element 1102 using a first beam 1106 and the second element 1104 using a second beam 1108. Each of the first element 1102 and the second element 1104 includes M=4 slots (with each slot having an uplink channel repetition). In the example of FIG. 11, the base station may perform cross-slot estimation with a time-domain bundling window of K=2. Accordingly, because there are at least two slots in each of the first element 1102 and the second element 1104, cross-slot estimation may be performed in K=2 consecutive slots of each of the first element 1102 and the second element 1104. Further, because M=4, there remain two additional slots in each of the first element 1102 and the second element 1104, and the base station may also perform cross-slot estimation (according to K=2) with these remaining slots (if the remaining slots are also consecutive).

Accordingly, a base station may determine a number of consecutive slots on the same beam that the UE should use to transmit uplink channel repetitions to the base station (e.g., may determine a value of M). The base station may then generate an indication that the UE is to accordingly use the number of consecutive slots on the same beam when transmitting uplink channel repetitions, and send this indication to the UE.

This indication may be sent in an RRC message. In other embodiments, this indication may be sent in a DCI message. When sent by a DCI message, the indication may be in the form of a TDRA indication for a TRDA known at the UE that contains the value M.

Alternatively, when sent by a DCI message, the indication may be in the form of a dedicated DCI field for M found in the DCI message.

In some embodiments, the base station may determine M based on the time-domain bundling window K. For example, it may be that the base station determines that M=K in cases where K>2; otherwise, the base station may determine that M=2.

In some embodiments, if the total number of uplink channel repetitions N is less than a value for M that would otherwise be determined, the base station determines that M=N.

In some embodiments, the base station may determine M to be an integer multiple (1, 2, . . . ) of the time-domain bundling window K (e.g., as reflected in FIG. 10 and FIG. 11).

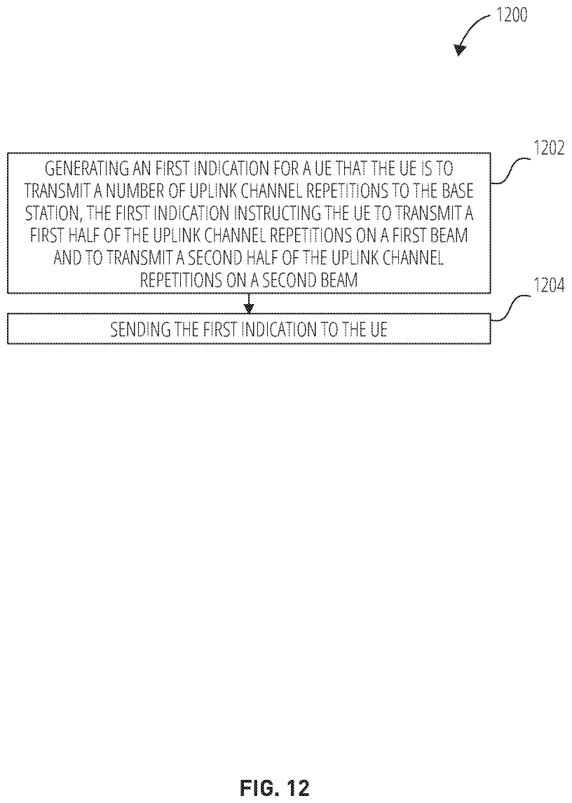

FIG. 12 illustrates a method 1200 of a base station, according to an embodiment. The method 1200 includes generating 1202 a first indication for a UE that the UE is to transmit a number of uplink channel repetitions to the base station, the first indication instructing the UE to transmit a first half of the uplink channel repetitions on a first beam and to transmit a second half of the uplink channel repetitions on a second beam.

The method 1200 further includes sending 1204 the first indication to the UE.

In some embodiments of the method 1200, each of the uplink channel repetitions corresponds to a different slot.

In some embodiments, the method 1200 further includes sending a second indication that cross-slot channel estimation is enabled to the UE.

Embodiments contemplated herein include an apparatus comprising means to perform one or more elements of the method 1200. This apparatus may be, for example, an apparatus of a base station (such as a network device 1718 that is a base station, as described herein).

Embodiments contemplated herein include one or more non-transitory computer-readable media comprising instructions to cause an electronic device, upon execution of the instructions by one or more processors of the electronic device, to perform one or more elements of the method 1200. This non-transitory computer-readable media may be, for example, a memory of a base station (such as a memory 1722 of a network device 1718 that is a base station, as described herein).

Embodiments contemplated herein include an apparatus comprising logic, modules, or circuitry to perform one or more elements of the method 1200. This apparatus may be, for example, an apparatus of a base station (such as a network device 1718 that is a base station, as described herein).

Embodiments contemplated herein include an apparatus comprising: one or more processors and one or more computer-readable media comprising instructions that, when executed by the one or more processors, cause the one or more processors to perform one or more elements of the method 1200. This apparatus may be, for example, an apparatus of a base station (such as a network device 1718 that is a base station, as described herein).

Embodiments contemplated herein include a signal as described in or related to one or more elements of the method 1200.

Embodiments contemplated herein include a computer program or computer program product comprising instructions, wherein execution of the program by a processing element is to cause the processing element to carry out one or more elements of the method 1200. The processor may be a processor of a base station (such as a processor(s) 1720 of a network device 1718 that is a base station, as described herein). These instructions may be, for example, located in the processor and/or on a memory of the base station (such as a memory 1722 of a network device 1718 that is a base station, as described herein).

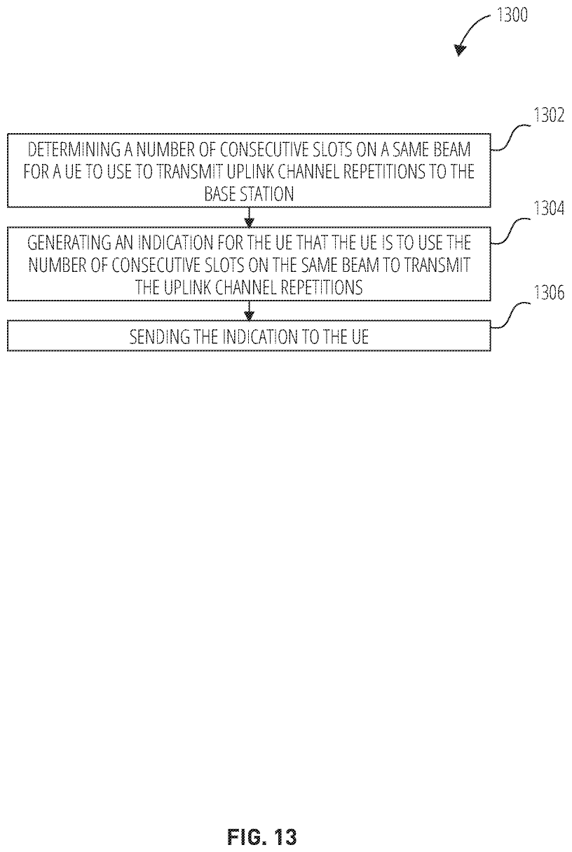

FIG. 13 illustrates a method 1300 of a base station, according to an embodiment. The method 1300 includes determining 1302 a number of consecutive slots on a same beam for a UE to use to transmit uplink channel repetitions to the base station.

The method 1300 further includes generating 1304 an indication for the UE that the UE is to use the number of consecutive slots on the same beam to transmit the uplink channel repetitions.

The method 1300 further includes sending 1306 the indication to the UE.

In some embodiments of the method 1300, the indication is sent in an RRC message.

In some embodiments of the method 1300, the indication is sent in a DCI message.

In some embodiments of the method 1300, the base station determines that the number of consecutive slots is equal to a number of slots of a time-domain bundling window.

In some embodiments of the method 1300, the number of consecutive slots is less than or equal to a number of the uplink channel repetitions.

Embodiments contemplated herein include an apparatus comprising means to perform one or more elements of the method 1300. This apparatus may be, for example, an apparatus of a base station (such as a network device 1718 that is a base station, as described herein).

Embodiments contemplated herein include one or more non-transitory computer-readable media comprising instructions to cause an electronic device, upon execution of the instructions by one or more processors of the electronic device, to perform one or more elements of the method 1300. This non-transitory computer-readable media may be, for example, a memory of a base station (such as a memory 1722 of a network device 1718 that is a base station, as described herein).

Embodiments contemplated herein include an apparatus comprising logic, modules, or circuitry to perform one or more elements of the method 1300. This apparatus may be, for example, an apparatus of a base station (such as a network device 1718 that is a base station, as described herein).

Embodiments contemplated herein include an apparatus comprising: one or more processors and one or more computer-readable media comprising instructions that, when executed by the one or more processors, cause the one or more processors to perform one or more elements of the method 1300. This apparatus may be, for example, an apparatus of a base station (such as a network device 1718 that is a base station, as described herein).

Embodiments contemplated herein include a signal as described in or related to one or more elements of the method 1300.

Embodiments contemplated herein include a computer program or computer program product comprising instructions, wherein execution of the program by a processing element is to cause the processing element to carry out one or more elements of the method 1300. The processor may be a processor of a base station (such as a processor(s) 1720 of a network device 1718 that is a base station, as described herein). These instructions may be, for example, located in the processor and/or on a memory of the base station (such as a memory 1722 of a network device 1718 that is a base station, as described herein).

A third issue impacting the interworking of uplink mTRP and uplink coverage enhancement may be that systems and methods that dynamically update the number of repetitions of a PUCCH by using DCI (described above as a third feature of uplink coverage enhancement) in the context of an environment where uplink mTRP can occur may not be defined.

One or more sets of spatial relation information may be configured for a PUCCH, and this configuration may be known to a UE. Each such set of spatial relation information may correspond to (e.g., identify) a different beam used during mTRP operation.

In some wireless communications systems, it may be that an indication of the number of repetitions of a PUCCH is determined relative to the number or sets of spatial relation information for the PUCCH. Accordingly, in some such systems, if the PUCCH is configured with a number Y of spatial relation information sets, then the system may restrict the number of repetitions of the PUCCH indicated by the DCI to be greater than or equal to Y (so that the beam of each set of spatial relation information for the PUCCH may be used for at least one repetition of the PUCCH).

However, this minimum restriction indicatednumberofPUCCHrepetitions≥Y) may cause unnecessary overhead. For example, in the case of good coverage of the UE, it may be that only one transmission of the PUCCH would be sufficient for signaling purposes (i.e., the PUCCH is not repeated). It has been recognized that this may be so even in the case where there is more than one set of spatial relation information for the PUCCH. Accordingly, it may be beneficial to not enforce a lower bound of Y on the number of PUCCH repetitions that may be signaled for in DCI (e.g., allow this value to be 1 (indicating a single PUCCH transmission), even when multiple sets of spatial relation information are configured for the PUCCH), and instead otherwise define system behavior in the case where a PUCCH associated with multiple (e.g., two) sets of spatial relation info (e.g., each corresponding to a different beam) is indicated to be sent only one time (for a single transmission of the PUCCH).

In a first option, the UE may, upon receiving an instruction to send a single transmission of the PUCCH, simply proceed to transmit a first repetition of the PUCCH on the first beam of the first set of the spatial relation information and a second repetition of the PUCCH on the second beam of the second set of the spatial relation information (despite the instruction from the base station).

In a second option, the UE selects one of the two sets of spatial relation information (e.g., selects the beam associated with that spatial relation information) to send a single transmission of the PUCCH. In a first embodiment of this second option, corresponding identifiers for the two sets of spatial relation information may be compared in order to facilitate this selection. For example, the set of spatial relation information with a lowest (or highest) pucch-spatialRelationInfold may be selected.

In a second embodiment of this second option, the base station dynamically indicates which set of spatial relation information is to be so used (e.g., to identify a beam) using DCI. In some cases, a separate DCI field may be provided for this purpose. In other cases, the set of spatial relation information to use may be determined relative to a starting control channel element (CCE) index for a PDCCH carrying the DCI. In some of these cases, an odd index may indicate the use of a first of the two sets of spatial relation information, and an even index may be used to indicate the use of a second of the two sets of spatial relation information.

In a third embodiment of this second option, the base station may indicate the spatial relation information that is to be so used (e.g., to identify a beam) using a medium access control (MAC) control element (MAC CE). In a first such case, the MAC CE may indicate the corresponding spatial relation information to use for the PUCCH (or the corresponding PUCCH resource group) by using a field of the MAC CE to indicate which set of spatial relation information should be used in the case that only one PUCCH transmission is configured for. In a second such case, the first set of spatial relation information indicated in the MAC CE should be used in the case that only one PUCCH transmission is configured for (e.g., the UE may be configured or pre-configured for this operation).

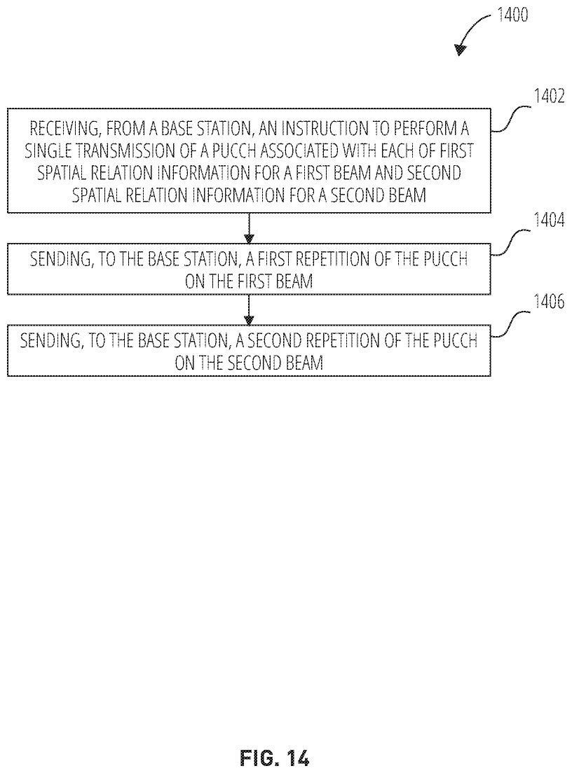

FIG. 14 illustrates a method 1400 of a UE, according to an embodiment. The method 1400 includes receiving 1402, from a base station, an instruction to perform a single transmission of a PUCCH associated with each of first spatial relation information for a first beam and second spatial relation information for a second beam.

The method 1400 further includes sending 1404, to the base station, a first repetition of the PUCCH on the first beam.

The method 1400 further includes sending 1406, to the base station, a second repetition of the PUCCH on the second beam.

Embodiments contemplated herein include an apparatus comprising means to perform one or more elements of the method 1400. This apparatus may be, for example, an apparatus of a UE (such as a wireless device 1702 that is a UE, as described herein).

Embodiments contemplated herein include one or more non-transitory computer-readable media comprising instructions to cause an electronic device, upon execution of the instructions by one or more processors of the electronic device, to perform one or more elements of the method 1400. This non-transitory computer-readable media may be, for example, a memory of a UE (such as a memory 1706 of a wireless device 1702 that is a UE, as described herein).

Embodiments contemplated herein include an apparatus comprising logic, modules, or circuitry to perform one or more elements of the method 1400. This apparatus may be, for example, an apparatus of a UE (such as a wireless device 1702 that is a UE, as described herein).

Embodiments contemplated herein include an apparatus comprising: one or more processors and one or more computer-readable media comprising instructions that, when executed by the one or more processors, cause the one or more processors to perform one or more elements of the method 1400. This apparatus may be, for example, an apparatus of a UE (such as a wireless device 1702 that is a UE, as described herein).

Embodiments contemplated herein include a signal as described in or related to one or more elements of the method 1400.

Embodiments contemplated herein include a computer program or computer program product comprising instructions, wherein execution of the program by a processor is to cause the processor to carry out one or more elements of the method 1400. The processor may be a processor of a UE (such as a processor(s) 1704 of a wireless device 1702 that is a UE, as described herein). These instructions may be, for example, located in the processor and/or on a memory of the UE (such as a memory 1706 of a wireless device 1702 that is a UE, as described herein).

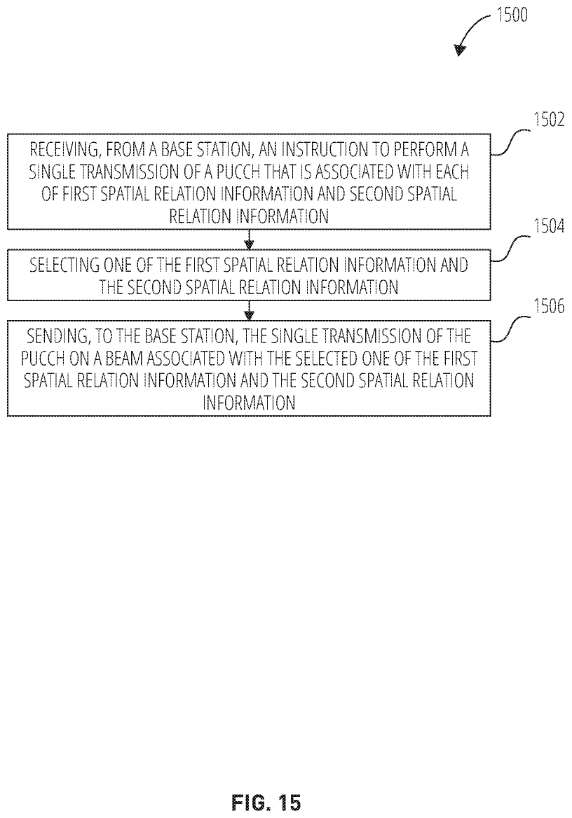

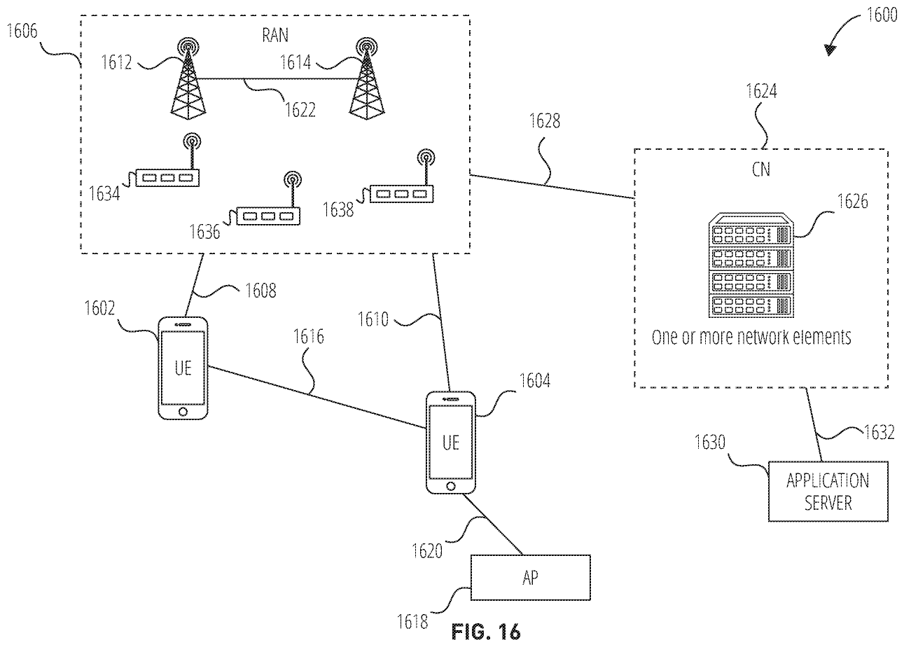

FIG. 15 illustrates a method 1500 of a UE, according to an embodiment. The method 1500 includes receiving 1502, from a base station, an instruction to perform a single transmission of a PUCCH that is associated with each of first spatial relation information and second spatial relation information.

The method 1500 further includes selecting 1504 one of the first spatial relation information and the second spatial relation information.

The method 1500 further includes sending 1506, to the base station, the single transmission of the PUCCH on a beam associated with the selected one of the first spatial relation information and the second spatial relation information.

In some embodiments of the method 1500, the one of the first spatial relation information and the second spatial relation information is selected based on a comparison of a first identifier for the first spatial relation information to a second identifier for the second spatial relation information.

In some embodiments, the method 1500 further includes receiving an indication of one of the first spatial relation information and the second spatial relation information in a DCI message from the base station; wherein the one of the first spatial relation information and the second spatial relation information is selected according to the indication.

In some embodiments of the method 1500, the instruction is received on a PDCCH, and wherein the one of the first spatial relation information and the second spatial relation information is selected based on a starting CCE index for the PDCCH.

In some embodiments, the method 1500 further includes receiving, from the base station, a MAC CE comprising a first indication the first spatial relation information is associated with the PUCCH and a second indication that the second spatial relation information is associated with the PUCCH; wherein the one of the first spatial relation information and the second spatial relation information is selected according to a third indication in the MAC CE.

In some embodiments, the method 1500 further includes receiving, from the base station, a MAC CE comprising a first indication the first spatial relation information is associated with the PUCCH and a second indication that the second spatial relation information is associated with the PUCCH; wherein the one of the first spatial relation information and the second spatial relation information is selected according to an ordering of the first indication and the second indication in the MAC CE.

Embodiments contemplated herein include an apparatus comprising means to perform one or more elements of the method 1500. This apparatus may be, for example, an apparatus of a UE (such as a wireless device 1702 that is a UE, as described herein).

Embodiments contemplated herein include one or more non-transitory computer-readable media comprising instructions to cause an electronic device, upon execution of the instructions by one or more processors of the electronic device, to perform one or more elements of the method 1500. This non-transitory computer-readable media may be, for example, a memory of a UE (such as a memory 1706 of a wireless device 1702 that is a UE, as described herein).

Embodiments contemplated herein include an apparatus comprising logic, modules, or circuitry to perform one or more elements of the method 1500. This apparatus may be, for example, an apparatus of a UE (such as a wireless device 1702 that is a UE, as described herein).

Embodiments contemplated herein include an apparatus comprising: one or more processors and one or more computer-readable media comprising instructions that, when executed by the one or more processors, cause the one or more processors to perform one or more elements of the method 1500. This apparatus may be, for example, an apparatus of a UE (such as a wireless device 1702 that is a UE, as described herein).

Embodiments contemplated herein include a signal as described in or related to one or more elements of the method 1500.

Embodiments contemplated herein include a computer program or computer program product comprising instructions, wherein execution of the program by a processor is to cause the processor to carry out one or more elements of the method 1500. The processor may be a processor of a UE (such as a processor(s) 1704 of a wireless device 1702 that is a UE, as described herein). These instructions may be, for example, located in the processor and/or on a memory of the UE (such as a memory 1706 of a wireless device 1702 that is a UE, as described herein).

FIG. 16 illustrates an example architecture of a wireless communication system 1600, according to embodiments disclosed herein. The following description is provided for an example wireless communication system 1600 that operates in conjunction with the LTE system standards and/or 5G or NR system standards as provided by 3GPP technical specifications.

As shown by FIG. 16, the wireless communication system 1600 includes UE 1602 and UE 1604 (although any number of UEs may be used). In this example, the UE 1602 and the UE 1604 are illustrated as smartphones (e.g., handheld touchscreen mobile computing devices connectable to one or more cellular networks), but may also comprise any mobile or non-mobile computing device configured for wireless communication.

The UE 1602 and UE 1604 may be configured to communicatively couple with a RAN 1606. In embodiments, the RAN 1606 may be NG-RAN, E-UTRAN, etc. The UE 1602 and UE 1604 utilize connections (or channels) (shown as connection 1608 and connection 1610, respectively) with the RAN 1606, each of which comprises a physical communications interface. The RAN 1606 can include one or more base stations, such as base station 1612 and base station 1614. Each of these may be understood to include (e.g., be collocated with) a TRP useable within the wireless communication system 1600 as such TRPs are discussed herein. The RAN 1606 can also include one or more remote TRPs, such as the remote TRP 1634, the remote TRP 1636, and the remote TRP 1638. Each of these may be understood to be TRPs useable within the wireless communication system 1600, as such TRPs are discussed herein. A base station of the RAN 1606 (e.g., the base station 1612 and/or the base station 1614 may operate with any TRP (e.g., with a TRP that is collocated on that base station, with a TRP located on/with another base station, and/or with a remote TRP), in the manner discussed herein.

One or more of the base station 1612, the base station 1614, the remote TRP 1634, the remote TRP 1636, and the remote TRP 1638 may enable the connection 1608 and connection 1610. In this example, the connection 1608 and connection 1610 are air interfaces to enable such communicative coupling, and may be consistent with RAT(s) used by the RAN 1606, such as, for example, an LTE and/or NR. A connection (such as the connection 1608 and/or the connection 1610) may use a plurality of beams, each corresponding to one of multiple TRPs of the RAN 1606 (as these are described above), in the manner described herein.

In some embodiments, the UE 1602 and UE 1604 may also directly exchange communication data via a sidelink interface 1616. The UE 1604 is shown to be configured to access an access point (shown as AP 1618) via connection 1620. By way of example, the connection 1620 can comprise a local wireless connection, such as a connection consistent with any IEEE 1102.11 protocol, wherein the AP 1618 may comprise a Wi-Fi® router. In this example, the AP 1618 may be connected to another network (for example, the Internet) without going through a CN 1624.

In embodiments, the UE 1602 and UE 1604 can be configured to communicate using orthogonal frequency division multiplexing (OFDM) communication signals with each other or with the base station 1612 and/or the base station 1614 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1612 or base station 1614 may be implemented as one or more software entities running on server computers as part of a virtual network. In addition, or in other embodiments, the base station 1612 or base station 1614 may be configured to communicate with one another via interface 1622. In embodiments where the wireless communication system 1600 is an LTE system (e.g., when the CN 1624 is an EPC), the interface 1622 may be an X2 interface. The X2 interface may be defined between two or more base stations (e.g., two or more eNBs and the like) that connect to an EPC, and/or between two eNBs connecting to the EPC. In embodiments where the wireless communication system 1600 is an NR system (e.g., when CN 1624 is a 5GC), the interface 1622 may be an Xn interface. The Xn interface is defined between two or more base stations (e.g., two or more gNBs and the like) that connect to 5GC, between a base station 1612 (e.g., a gNB) connecting to 5GC and an eNB, and/or between two eNBs connecting to 5GC (e.g., CN 1624).

The RAN 1606 is shown to be communicatively coupled to the CN 1624. The CN 1624 may comprise one or more network elements 1626, which are configured to offer various data and telecommunications services to customers/subscribers (e.g., users of UE 1602 and UE 1604) who are connected to the CN 1624 via the RAN 1606. The components of the CN 1624 may be implemented in one physical device or separate physical devices including components to read and execute instructions from a machine-readable or computer-readable medium (e.g., a non-transitory machine-readable storage medium).

In embodiments, the CN 1624 may be an EPC, and the RAN 1606 may be connected with the CN 1624 via an S1 interface 1628. In embodiments, the S1 interface 1628 may be split into two parts, an S1 user plane (S1-U) interface, which carries traffic data between the base station 1612 or base station 1614 and a serving gateway (S-GW), and the S1-MME interface, which is a signaling interface between the base station 1612 or base station 1614 and mobility management entities (MMEs).

In embodiments, the CN 1624 may be a 5GC, and the RAN 1606 may be connected with the CN 1624 via an NG interface 1628. In embodiments, the NG interface 1628 may be split into two parts, an NG user plane (NG-U) interface, which carries traffic data between the base station 1612 or base station 1614 and a user plane function (UPF), and the S1 control plane (NG-C) interface, which is a signaling interface between the base station 1612 or base station 1614 and access and mobility management functions (AMFs).

Generally, an application server 1630 may be an element offering applications that use internet protocol (IP) bearer resources with the CN 1624 (e.g., packet switched data services). The application server 1630 can also be configured to support one or more communication services (e.g., VoIP sessions, group communication sessions, etc.) for the UE 1602 and UE 1604 via the CN 1624. The application server 1630 may communicate with the CN 1624 through an IP communications interface 1632.

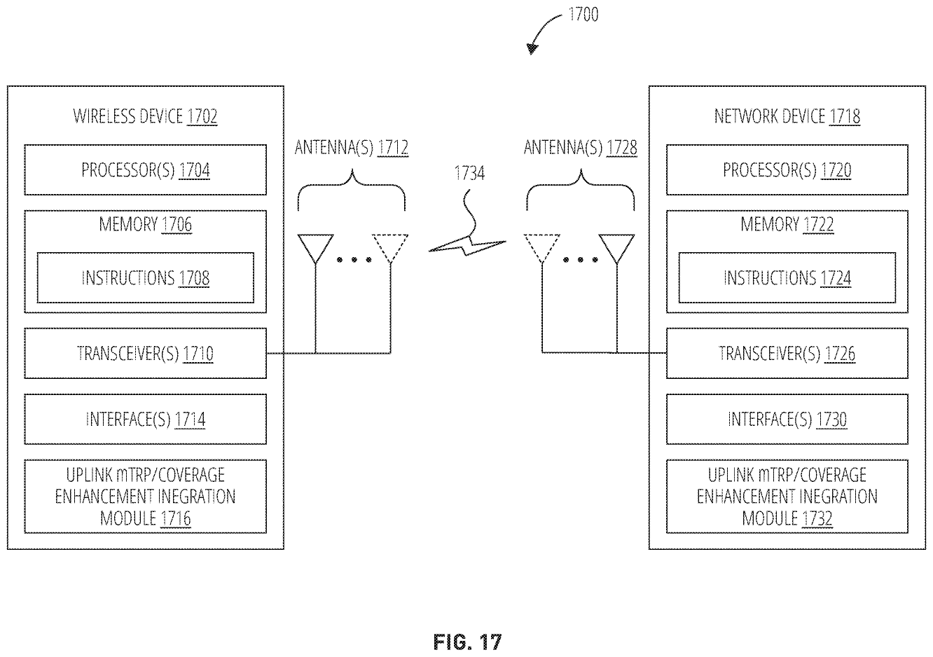

FIG. 17 illustrates a system 1700 for performing signaling 1734 between a wireless device 1702 and a network device 1718, according to embodiments disclosed herein. The system 1700 may be a portion of a wireless communications system as herein described. The wireless device 1702 may be, for example, a UE of a wireless communication system. The network device 1718 may be, for example, a base station (e.g., an eNB or a gNB) of a wireless communication system. In other cases, the network device 1718 having some or all of the elements illustrated within the network device 1718 may be a remote TRP used by a base station.

The wireless device 1702 may include one or more processor(s) 1704. The processor(s) 1704 may execute instructions such that various operations of the wireless device 1702 are performed, as described herein. The processor(s) 1704 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1702 may include a memory 1706. The memory 1706 may be a non-transitory computer-readable storage medium that stores instructions 1708 (which may include, for example, the instructions being executed by the processor(s) 1704). The instructions 1708 may also be referred to as program code or a computer program. The memory 1706 may also store data used by, and results computed by, the processor(s) 1704.

The wireless device 1702 may include one or more transceiver(s) 1710 that may include radio frequency (RF) transmitter and/or receiver circuitry that use the antenna(s) 1712 of the wireless device 1702 to facilitate signaling (e.g., the signaling 1734) to and/or from the wireless device 1702 with other devices (e.g., the network device 1718) according to corresponding RATs.

The wireless device 1702 may include one or more antenna(s) 1712 (e.g., one, two, four, or more). For embodiments with multiple antenna(s) 1712, the wireless device 1702 may leverage the spatial diversity of such multiple antenna(s) 1712 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1702 may be accomplished according to precoding (or digital beamforming) that is applied at the wireless device 1702 that multiplexes the data streams across the antenna(s) 1712 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1702 may implement analog beamforming techniques, whereby phases of the signals sent by the antenna(s) 1712 are relatively adjusted such that the (joint) transmission of the antenna(s) 1712 can be directed (this is sometimes referred to as beam steering).

The wireless device 1702 may include one or more interface(s) 1714. The interface(s) 1714 may be used to provide input to or output from the wireless device 1702. For example, a wireless device 1702 that is a UE may include interface(s) 1714 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 1710/antenna(s) 1712 already described) that allow for communication between the UE and other devices and may operate according to known protocols (e.g., Wi-Fi®, Bluetooth®, and the like).

The wireless device 1702 may include an uplink mTRP/coverage enhancement integration module 1716. The uplink mTRP/coverage enhancement integration module 1716 may be implemented via hardware, software, or combinations thereof. For example, the uplink mTRP/coverage enhancement integration module 1716 may be implemented as a processor, circuit, and/or instructions 1708 stored in the memory 1706 and executed by the processor(s) 1704. In some examples, the uplink mTRP/coverage enhancement integration module 1716 may be integrated within the processor(s) 1704 and/or the transceiver(s) 1710. For example, the uplink mTRP/coverage enhancement integration module 1716 may be implemented by a combination of software components (e.g., executed by a DSP or a general processor) and hardware components (e.g., logic gates and circuitry) within the processor(s) 1704 or the transceiver(s) 1710.

The uplink mTRP/coverage enhancement integration module 1716 may be used for various aspects of the present disclosure, for example, aspects of FIG. 3 through FIG. 15. The uplink mTRP/coverage enhancement integration module 1716 may configure the wireless device 1702 to use uplink mTRP along with methods for transmitting a TB of an uplink channel over multiple slots, to use uplink mTRP along with methods enabling cross-slot channel estimation at a base station (e.g., the network device 1718), and/or to use uplink mTRP along with methods where a base station (e.g., the network device 1718) can dynamically update the number of transmissions of a PUCCH by using DCI (e.g., to instruct the wireless device 1702 to transmit a single PUCCH transmission), as described herein.

The network device 1718 may include one or more processor(s) 1720. The processor(s) 1720 may execute instructions such that various operations of the network device 1718 are performed, as described herein. The processor(s) 1720 may include one or more baseband processors implemented using, for example, a CPU, a DSP, an ASIC, a controller, an FPGA device, another hardware device, a firmware device, or any combination thereof configured to perform the operations described herein.

The network device 1718 may include a memory 1722. The memory 1722 may be a non-transitory computer-readable storage medium that stores instructions 1724 (which may include, for example, the instructions being executed by the processor(s) 1720). The instructions 1724 may also be referred to as program code or a computer program. The memory 1722 may also store data used by, and results computed by, the processor(s) 1720.

The network device 1718 may include one or more transceiver(s) 1726 that may include RF transmitter and/or receiver circuitry that use the antenna(s) 1728 of the network device 1718 to facilitate signaling (e.g., the signaling 1734) to and/or from the network device 1718 with other devices (e.g., the wireless device 1702) according to corresponding RATs.

The network device 1718 may include one or more antenna(s) 1728 (e.g., one, two, four, or more). In embodiments having multiple antenna(s) 1728, the network device 1718 may perform MIMO, digital beamforming, analog beamforming, beam steering, etc., as has been described.

The network device 1718 may include one or more interface(s) 1730. The interface(s) 1730 may be used to provide input to or output from the network device 1718. For example, a network device 1718 that is a base station may include interface(s) 1730 made up of transmitters, receivers, and other circuitry (e.g., other than the transceiver(s) 1726/antenna(s) 1728 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1718 may include an uplink mTRP/coverage enhancement integration module 1732. The uplink mTRP/coverage enhancement integration module 1732 may be implemented via hardware, software, or combinations thereof. For example, the uplink m TRP/coverage enhancement integration module 1732 may be implemented as a processor, circuit, and/or instructions 1724 stored in the memory 1722 and executed by the processor(s) 1720. In some examples, the uplink mTRP/coverage enhancement integration module 1732 may be integrated within the processor(s) 1720 and/or the transceiver(s) 1726. For example, the uplink mTRP/coverage enhancement integration module 1732 may be implemented by a combination of software components (e.g., executed by a DSP or a general processor) and hardware components (e.g., logic gates and circuitry) within the processor(s) 1720 or the transceiver(s) 1726.

The uplink mTRP/coverage enhancement integration module 1732 may be used for various aspects of the present disclosure, for example, aspects of FIG. 3 through FIG. 15. The uplink mTRP/coverage enhancement integration module 1732 may configure the wireless network device 1718 to configure uplink mTRP along with cases where e.g., the wireless device 1702 transmits a TB of an uplink channel over multiple slots, to use configure mTRP (e.g., by the wireless device 1702) such that it enables cross-slot channel estimation methods at the wireless device 1702, and/or to configure uplink mTRP for use with methods where the network device 1718 can dynamically update the number of transmissions of a PUCCH by using DCI (e.g., to instruct the wireless device 1702 to transmit a single PUCCH transmission), as described herein.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1-7. (canceled)

8. A method of a base station, comprising:
sending a first indication to a user equipment (UE) capable of multiple transmission reception point (TRP) operation that the UE is to use a beam mapping pattern over a plurality of slots, the beam mapping pattern comprising a plurality of elements that each include one or more slots of the plurality of slots, wherein each element of the plurality of elements corresponds to a use of one of a first beam for a first TRP or a second beam for a second TRP during the one or more slots of the element; and
sending, to the UE, a second indication that schedules a transmission by the UE of a transport block (TB) of an uplink channel across multiple slots of the plurality of slots to one or more of the first TRP and the second TRP.

9. The method of claim 8, wherein the multiple slots are located in a same element of the beam mapping pattern that corresponds to the use of the first beam.

10. The method of claim 8, wherein a first slot of the multiple slots is located in a first element of the beam mapping pattern that corresponds to a use of the first beam and a second slot of the multiple slots is located in a second element of the beam mapping pattern that corresponds to the use of the first beam.

11. The method of claim 8, wherein a first slot of the multiple slots is located in a first element of the beam mapping pattern that corresponds to a use of the first beam and a second slot of the multiple slots is located in a second element of the beam mapping pattern that corresponds to a use of the second beam.

12. The method of claim 8, wherein the first indication and the second indication are sent in a single message.

13. The method of claim 12, wherein the single message is a downlink control information (DCI) message.

14. The method of claim 8, wherein the first indication is sent in a first message, and wherein the second indication is provided in a second message.

15. The method of claim 14, wherein the first message is a radio resource control (RRC) message, and the second message is a downlink control information (DCI) message.

16. The method of claim 14, wherein the first message is transmitted after the second message is transmitted.

17. The method of claim 8, further comprising:
receiving, from the UE, a third indication of whether the UE is capable of dividing the multiple slots between a first element of the beam mapping pattern that corresponds to a use of the first beam a second element of the beam mapping pattern that corresponds to a use of the second beam.

18. The method of claim 8, further comprising:
sending, to the UE, a third indication of whether the multiple slots will be scheduled using each of a first element of the beam mapping pattern that corresponds to a use of the first beam a second element of the beam mapping pattern that corresponds to a use of the second beam.

19. The method of claim 18, wherein the third indication is sent in a radio resource control (RRC) message.

20. The method of claim 18, wherein the third indication is sent in a downlink control information (DCI) message.

21. The method of claim 20, wherein the third indication is made by referencing a time domain resource allocation (TDRA) configuring for the use of one or more of the first element and the second element.

22. A method of a user equipment (UE), comprising:
generating a first power headroom report (PHR) for an uplink channel that comprises multiple slots, the first PHR corresponding to a first TRP, wherein a transport block (TB) of the uplink channel is to be transmitted across the multiple slots; and
transmitting the first PHR to the first TRP.

23. The method of claim 22, wherein the first PHR is a virtual PHR.

24. The method of claim 22, wherein the first PHR is an actual PHR that is calculated based on a power control setting of a first slot of the multiple slots.

25. The method of claim 22, further comprising:
generating a second PHR for the uplink channel, the second PHR corresponding to a second TRP; and
transmitting the second PHR to the second TRP.

26. The method of claim 25, wherein a first portion of the multiple slots are used to transmit a first portion of the TB, and wherein a second portion of the multiple slots are used to transmit a second portion of the TB.

27. The method of claim 25, wherein:
the first PHR is a first virtual PHR calculated based on first default power settings for the first TRP, and
the second PHR is a second virtual PHR that is calculated based on second default power control settings for the second TRP.

28-43. (canceled)
